(19) United States
(12) Patent Application Publication
(10) Pub. No.: US 2003/0235119 A1
(43) Pub. Date: Dec. 25, 2003

(54) Expiration date system

(76) Inventors: Abraham Wien, Miami, FL (US); Ira Schwartz, Miami, FL (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/333,093

(22) PCT Filed: Jul. 17, 2001
(86) PCT No.: PCT/US01/22487

(51) Int. Cl. G04C 1/00

(52) U.S. Cl. 368/327

(57) ABSTRACT

This invention relates to expiration date systems in general, and particularly to a new expiration date system (14) which employs a time release mechanism to overcome the problems inherent in expiration date systems used today.

### FIELD OF THE INVENTION

This invention relates to expiration date systems in general, and particularly to a new expiration date system (NEDS) which employs a time release mechanism to overcome the problems inherent in expiration date systems used today.

### BACKGROUND OF THE INVENTION

The current conventional method of alerting consumers to the expiration date of perishable items such as pharmaceuticals and food products involves imprinting the expiration date on the actual product or attaching a printed label indicating the expiration date onto the product or its packaging. Consumers are expected to heed the expiration date affixed onto the packaging but very often do not.

Prior expiration date systems have not solved or satisfactorily addressed the problems inherent with expiration date systems intended to alert consumers to the expiration date of the useful life of a perishable product. The current conventional method of alerting consumers to expiration dates is inefficient and unsatisfactory since many consumers fail to take notice of the expiration date indicated on the product or may dispose of the packaging imprinted with the expiration date once the product is unwrapped. Furthermore, the deficiencies inherent in current expiration date systems can potentially cause physical harm to the consumer when the consumer fails to heed the expiration date and uses or consumes a product whose expiration date has passed.

### PRIOR ART

U.S. Pat. No. 5,923,407 discloses a technique for activating and deactivating the availability of image borders as a function of time. According to one aspect of such technique there is provided a method for use with a digital image editing system that combines an input image with a border selected from a storage medium of borders if the current date is within the design border's availability date.

U.S. Pat. No. 4,938,380 discloses a method of warning a prospective purchaser of perishable goods with information pertaining to one or more predetermined detrimental factor or factors such as the passage of time. One feature of the method is to protect retail customers from unwittingly purchasing perishable items that may have undergone one of the predetermined detrimental factors. The method of U.S. Pat. No. 4,938,380 includes use in conjunction with an optical scanning device whereby one or more of the factors may be read by a customer or by a scanning machine at the time of checkout.

The two patents cited herein above are incorporated by reference in their entirety.

### NOVELTY OF THE PRESENT INVENTION

Neither of these two patents address the problems encountered by consumers of perishable products and instead are geared toward industrial or retail use. Further, these inventions require sophisticated equipment not commonly found among consumers. In addition, the conventional expiration system currently in use fails to account for double expiration dates since customers seldom record the date when they open a sealed product. By double expiration date, we mean that the first expiration date is the expiration date of the unopened product sitting on the shelf, also sometimes referred to as “shelf-life”, the second expiration date being the life of the product once opened by the consumer. Conventional expiration date systems are further deficient since they fail to take into account certain external factors which may accelerate or prolong the expiration date of certain products, e.g., heat, light, refrigeration, exposure to atmosphere, etc.

The new expiration date system of the present invention eliminates these problems by actively and efficiently alerting the consumer to the expiration date of the designated perishable product which are typically dependent on such factors as time and temperature. Accordingly, there is a need for a system that efficiently alerts the consumer to the end of the useful life of a perishable product based upon the passage of time as well as environmental factors such as temperature, light, and exposure to atmosphere.

### SUMMARY OF INVENTION

This invention relates to expiration date systems in general, and particularly to a new expiration date system (NEDS) which employs a time release mechanism to overcome the problems inherent in expiration date systems used today. The expiration date system of the present invention alerts consumers to the expiration date of perishable products such as foods and pharmaceuticals by means of a time release chemical indicator and may be adapted for a specific use such as a double expiration date or may take into account specific conditions effecting the useful life span of a particular product, e.g., temperature, heat, light, etc.

### BRIEF DESCRIPTION OF THE DRAWINGS

FIG. 1 is a side view of a container equipped with the expiration date system of the present invention, having an exploded portion of the expiration date system of the present invention;

FIG. 2 is a side sectional view of an embodiment of the expiration date system of the present invention; and

FIG. 3 is a side sectional view of an embodiment of the expiration date system of the present invention.

### DETAILED DESCRIPTION OF PREFERRED EMBODIMENTS

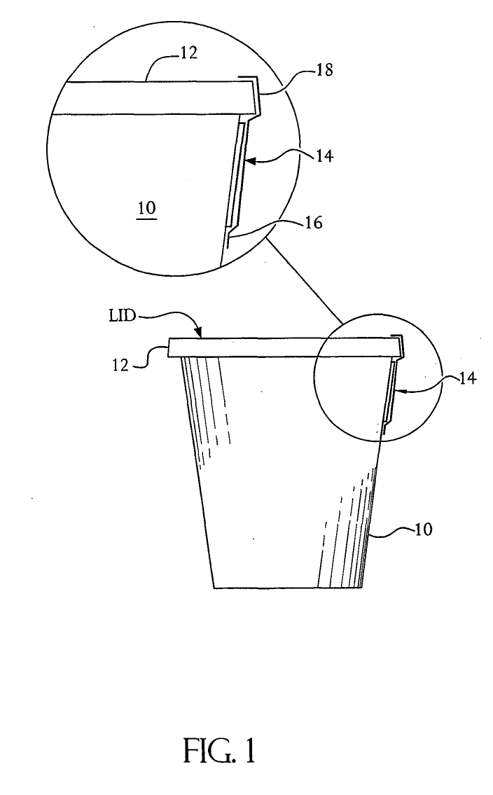

As shown in FIG. 1, a typical container 10 having a conventional lid 12 which seals the container from external factors and from spilling the container contents may be used to hold a wide variety of perishable products (not shown).

An expiration date system 14 in accordance with the present invention, may be utilized to show the expiration date of the product contained in container 10. As shown in the enlarged portion of FIG. 1, the expiration date system 14, maybe adhesively secured in accordance with conventional methods at its lower end 16 to the side of the container 10. The upper portion 18 of the expiration date system 14 may be fixedly secured in accordance with conventional methods to the lid 12. Thus, when a consumer opens the product contained in the container 10 by removing the lid 12, the system 14 of the present invention is activated when the seal is broken.

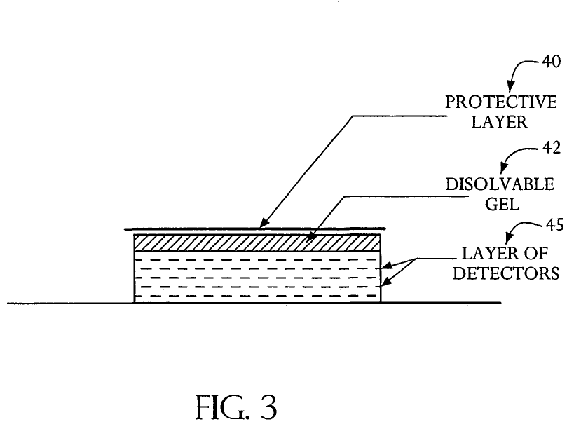

Alternatively in the “Self-Contained New Expiration Date System (SCNEDS)” embodiment as shown in FIG. 3, the consumer peels away an outer protective layer of the system 40, to activate the chemical components of the system 45, in accordance with the present invention, to begin measuring the period of expiration for the particular product contained in the container 10.

As will be described in further detail below, the present invention includes two types of systems. One system in accordance with the present invention is “Self-Contained New Expiration Date System (SCNEDS)” and does not rely upon exposure of the product and/or container to outside elements to indicate product expiration. This type of system is usually used by the manufacturer to provide an indicator of the shelf-life of the product.

The second system in accordance with the present invention is sensitive to environmental and other factors such as external temperature, time, etc. and may also be activated by the consumer once the product's packaging is opened, e.g., a container of milk, etc.

One embodiment of the new expiration date system of the present invention is a pre-manufactured expiration date label capable, through various means, of alerting the consumer to the expiration date of the corresponding perishable product. The label or tag is activated once affixed directly onto the relevant perishable product or its packaging. In some embodiments, the system will require further action by the consumer to begin activation, e.g., by removing an outer protective layer which then exposes the remainder of the system to environmental conditions.

As described in further detail below, and as shown in FIG. 3, one of the means by which the expiration system of the present invention can be activated by the consumer or the manufacturer comprises the step of peeling a seal 40 or pulling a pre-determined tear from a conventional label serving as a protective layer, thereby activating by exposure to the atmosphere, a chemical substance contained within the label. The chemical substance is formulated to measure the useful life span of a specific perishable product and to provide an indicator to the consumer upon the expiration date of the product. The indicator may be a written message, a change in color, or a change from opaqueness to transparency or the reverse.

Another embodiment of the present invention includes an indicator in the form of a bar strip which may be activated by the consumer or the manufacturer by removing a protective layer and exposing the bar strip indicator to the atmosphere. The strip is treated with a chemical compound indicator preformulated to measure the useful life span of the specific product. Once activated, the strip will provide a progressive visual indicator as a function of time corresponding to the useful life span of the perishable product. A notice accompanying the bar strip will instruct the consumer that the progressive change occurring along the strip demarcates the time remaining in the useful life span of the product. As with the other embodiments of the present invention the bar strip chemical compound may provide an indicator by progressively turning a designated color, darkening, becoming transparent or opaque, depending upon the chemical used and/or the application thereof. In addition, the system may also function by means of a chemical substance or ink pre-formulated to provide an indicator according to the useful life span of the specific product. The chemical substance, like ink, may be applied directly to the product or its packaging by conventional printing methods.

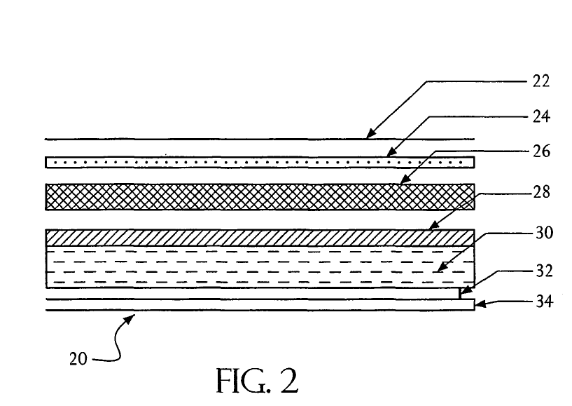

As shown in FIG. 1, one embodiment of the present invention takes into account “double expiration dates” for sealed products whose expiration date begins to toll once the product is opened by the consumer since most consumers will seldom record the date on which the product was opened. This embodiment of the new expiration date system (NEDS) 14 of the present invention can be adapted for perishable products having double expiration dates whereby the label 14 is fixed onto the product's packaging 10 in the manner of a tamper proof seal such that when the seal is broken by the consumer the time release chemical component of the label is activated. The secondary expiration label is activated by breaking a protective foil or membrane as shown in FIG. 1, and described in further detail below. Another embodiment of the NEDS is shown in FIG. 2, as described below in relationship to that Figure, except that the NEDS embodiment does not include the dissolvable gel or layer of detectors described below.

For products having a double expiration date, the system of the present invention may provide an expiration indicator for both the sealed retail shelf life as well the second expiration date which tolls after the breaking of the sealed micro environment or packaging.

Another embodiment of the present invention consists of an expiration date system customized to detect and take into account predetermined variables and thus provide a customized new expiration date system (CNEDS). The CNEDS embodiment will take into account that for some perishables, the expiration date may be accelerated if the product is subjected to extreme temperatures, sunlight or other harsh external conditions. For example, milk spoils at a faster rate if not refrigerated versus being refrigerated. The present invention is meant to take this into account and provide the consumer with information regarding product spoilage under these circumstances.

As shown in FIG. 2, another embodiment of the present invention addresses the problem of external variables which cannot be reliably predicted so as to create a customized system. In such instances, the self-contained new expiration date system of the present invention (SCNEDS) may be implemented which will degrade at a constant, predetermined rate independent of external factors. The self-contained new expiration date system of the present invention is activated by removing a protective layer or foil thereby exposing a layer of dissolvable gel. Once the gel layer dissolves, chemical indicators located within the expiration date system will trigger the indicator or chemical compound which will begin to degrade at a constant rate.

The chemical component provides an indicator to the consumer by various means such as a change of color, darkening or becoming colorless or clear. One embodiment of the time release chemical component indicator provides a written warning message on the label to the consumer such as “product has expired.”

In accordance with the present invention, the chemicals capable of providing an indicator to the consumer of the product expiration and/or shelf life may react by various mechanisms triggered by the passage of time and predetermined environmental factors and may be organic or inorganic. The chemical component may be adapted to account for one or more environmental variables which may shorten or extend the life of a product such as light, heat, refrigeration, exposure to humidity, water, oxygen and/or carbon dioxide.

Chemical Indicators

There are many chemical compounds that are light and /or oxygen sensitive which degrade with time that may be used with the New Expiration Date System (NEDS), the CNEDS and the SCNEDS of the present invention, some of these compounds are organic chemicals and some are inorganic chemicals.

Organic Chemical Compounds:

The following are stable chemicals which when combined with one or more metal ions will make the compound light and oxygen sensitive and will degrade with time and maybe used with the present invention.

a) Phytalocyamines: this class of chemicals has a blue color pigment.

b) Porphyrins: this class of chemicals has a red color pigment.

These chemicals are then utilized in accordance with the present invention as described herein.

The following chemicals are also useful in the present invention, but need not be combined with a metal ion to become light and oxygen sensitive and degrade with time:

a) Ferrocenes: Iron (I) subclass; these subclasses of chemicals have a yellow color pigment; Iron (m) subclass: these subclasses of chemicals have a purple color pigment.

b) Flavonoids: these compounds are light and oxygen sensitive and will change colors with time.

Inorganic Chemical Compounds:

The following compounds are light and oxygen sensitive and will degrade with time:

a) Inorganic Salts: these compounds are light and oxygen sensitive and will change color over time.

b) Transition Metals: e.g., manganese, cobalt, iron, vanadium and many others, may also be used in accordance with the present invention.

### EXAMPLES

The following represent examples of the chemical components to be used in the EXPIRATION DATE SYSTEM, as well as the activating atmospheric components and resulting color changes.

| Expiration System | Atmospheric | Indicator or Color |
|---|---|---|
| Chemical Component | Activator | Change |
| Iron (II) Sulfate changes to | O₂ | Green to |
| Iron (III) Sulfate | (Oxygen) | Brown |
| Copper (II) Sulfate to | H₂O | White to |
| Copper (II) Sulfate Hydrate | (Water) | Blue |
| Sodium Hydroxide | CO₂ | From White to a color to |
| | (Carbon Dioxide) | be determined by |
| | | metallic component |
| | | added to the |
| | | Sodium Hydroxide |
| Protoperphyrin IX | Combination of | Red to |
| Dimethylester | light and oxygen | Green |

In accordance with the present invention, and in ways known to one skilled in the art, the shelf-life expiration period for a product will vary depending upon such factors as the product itself and the manner in which the product is packaged, e.g., in glass, plastic, cellophane, metal.

The present invention can be adapted for use with each of these systems by varying the quantity and concentration of the chemical compound use, by mixing the chemical compounds of the present invention with a gelatin substance at different concentrations, and/or by varying the amount and concentration of metal ion(s) in the organic chemical compounds.

As shown in FIG. 2, one embodiment 20 of the new expiration date system of the present invention (SCNEDS) includes an exterior protective layer 22 made of conventional foil or other similar protective materials that the consumer may remove to activate the chemical component in accordance with the present invention. Below the exterior protective layer 22, is a protective membrane 24, which may be a clear or opaque plastic cover that is also porous and allows for light and/or oxygen to activate the chemical component 26 as well as to keep the chemical component 26 as previously described, in place.

In the Self-Contained New Expiration Date System (SCNEDS) embodiment of the present invention shown in FIG. 2, that embodiment includes a dissolvable gel 28 and layer of detectors 30. The dissolvable gel 28 is made from water dissolvable polymers.

The layer of detector 30 maybe made from polymers and simple chemical compounds.

In the NEDS of the present invention, the dissolvable gel 28 and the layer of detectors 30 are not present.

The embodiment 20, of FIG. 2, also includes a conventional plastic backing 32 to provide support for the other components of the expiration date system of the present invention. The plastic backing 32 may be secured in a removable or more permanent fashion by use of one or more conventional adhesives 34 to secure the device 20 to a conventional container in accordance with the present invention.

Without further elaboration, the foregoing specification provides exemplary use of the invention and is not meant to limit the invention in any manner, and maybe adapted for use in accordance with various uses in manners known to those skilled in the art.

1. An expiration date system to protect consumers and provide consumers with information to alert the consumer to an expiration date on a perishable product, the system comprising:
(a) an outer protective layer;
(b) a protective membrane;
(c) a chemical component to indicate the expiration date of the product, the chemical component including one or more ferrocenes, flavonoids inorganic salts, transition metals;
(d) optionally a gel;
(e) optionally a layer of one or more detectors; and
(f) a plastic backing.

2. The system of claim 1 wherein the ferrocene is selected from the group consisting of Iron (II) Sulfate, Iron (III) Sulfate, and Copper (II) Sulfate.

3. The system of claim 1 wherein a phenolic compound is selected from the group consisting of flavonoids.

4. The system of claim 1 wherein an inorganic salt is selected.

5. The system of claim 1 wherein the transition metal is selected from the group consisting of manganese, cobalt and vanadium.

6. The system of claim 1 wherein the layer of detectors comprises simple chemical compounds or polymers.

7. The system of claim 1 wherein the system is activated by removing the protective layer from the system.

8. The system of claim 1 wherein the information provided to the consumer regarding the expiration date of the product is in the form of a written message.

9. The system of claim 1 wherein the information provided to the consumer regarding the expiration date of the product is in the form of a change in color.

10. The system of claim 1 wherein the information provided to the consumer regarding the expiration date of the product is in the form of a change from opaqueness to transparency.

11. The system of claim 1 wherein the information provided to the consumer regarding the expiration date of the product is in the form of a change from transparency to opaqueness.

12. An expiration date system to protect a consumer and provide the consumer with information to alert the consumer to an expiration date on a perishable product, the system comprising:
(a) at least one layer;
(b) a chemical component to indicate the expiration date of the product, the chemical component being sensitive to light, temperature, and/or atmosphere;

13. The system of claim 12 wherein the chemical component is one or more ferrocene, 'flavonoid, inorganic salt or transition metal.

14. The system of claim 1, wherein the system provides an expiration indicator for both the sealed retail shelf life of the product as well a second expiration date which tolls after the breaking of the product's sealed micro environment or packaging.

15. The system of claim 12, wherein the system provides an expiration indicator for both the sealed retail shelf life of the product as well a second expiration date which tolls after the breaking of the product's sealed micro environment or packaging.

16. The system of claim 1, wherein the system takes the form of a bar strip whereby the information to the alert the consumer to an expiration date takes the form of visually apparent progressive change occurring along the strip to demarcate the time remaining in the useful life span of the product.

17. The system of claim 12, wherein the system takes the form of a bar strip whereby the information to the alert the consumer to an expiration date takes the form of visually apparent progressive change occurring along the strip to demarcate the time remaining in the useful life span of the product.
